(19) United States
(12) Patent Application Publication
(10) Pub. No.: US 2010/0163486 A1
(43) Pub. Date: Jul. 1, 2010

(54) METHOD OF OBTAINING A COAGULANT PRODUCT, PRODUCT INTENDED TO PRODUCE SAID COAGULANT, AND METHOD OF TREATING WASTE WATER AND/OR INDUSTRIAL WATER USING SAID COAGULANT

(75) Inventors: Hervé Suty, Champigny Sur Marne (FR); Marc Caligaris, Conflans-sainte-honorine (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: VELOLIA EAU-COMPAGNIE GENERALE DES EAUX, Paris (FR)

(21) Appl. No.: 12/294,764

(22) PCT Filed: Mar. 27, 2007
(86) PCT No.: PCT/FR2007/051020

§ 371 Date: Feb. 17, 2010

(30) Foreign Application Priority Data
Mar. 27, 2006 (FR) 0651042

(51) Int. Cl. C02F 1/52; C09K 3/00

(52) U.S. Cl. 210/638; 210/717; 210/708; 252/182.33; 252/182.35

(57) ABSTRACT

The invention relates to a method of producing a coagulant product. It is characterized in that a starting material is prepared containing sludge resulting from the treatment of drinking water and an ore containing iron and/or aluminum, said starting material undergoing acid attack to form iron salts, aluminum salts or a mixture thereof. Application of said coagulant during implementation of a physico-chemical step of the treatment of waste water and/or industrial water.

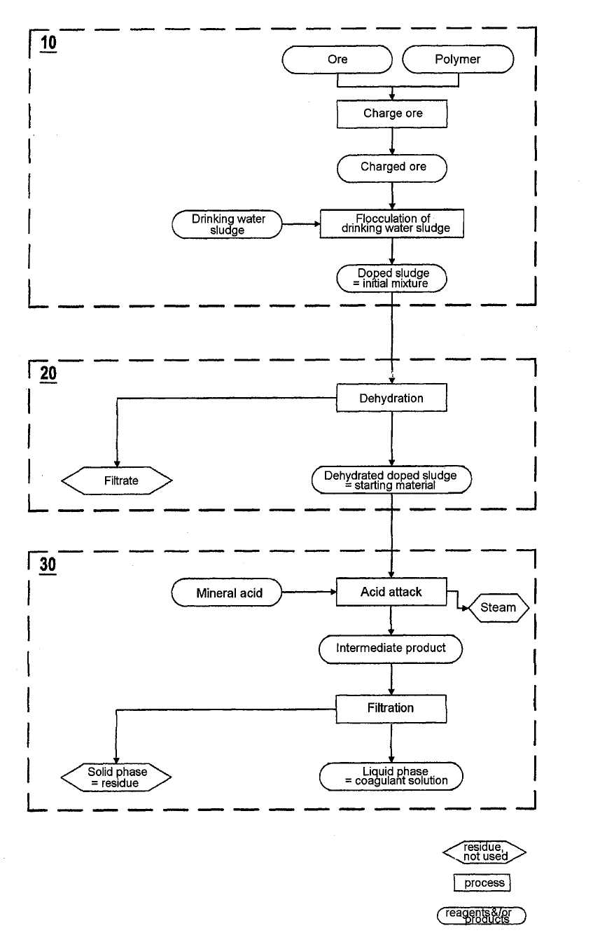

The invention relates to a method of obtaining a coagulant product that may in particular be used for the treatment of waste water, whether it be municipal and/or industrial waste water.

Normally, a dephosphatation step is carried out when treating waste water, in particular physico-chemical dephosphatation. To this end, precipitation is carried out using lime or salts containing trivalent ions, in particular using iron or aluminum chloride. In some regions, ferric chloride, FeCl₃, is used almost exclusively, in large quantities, in said physico-chemical dephosphatation step.

At the same time, it is known that when treating drinking water, the resulting residues, and in particular drinking water sludge or settling sludge, contain trivalent ion salts. In fact, in the conventional steps of treating water intended for consumption, a coagulant based on trivalent ions, in particular ferric or aluminum, is used, and thus the solid residues from that treatment contain said elements, in particular in the form of ferric chloride, or aluminum sulfate or chloride.

Attempts have already been carried out to recover said salts or coagulants contained in drinking water sludge.

Thus, for example, in United States patents U.S. Pat. No. 5,720,882 or U.S. Pat. No. 4,448,696, drinking water sludge (dehydrated or thickened) resulting from water treatment is recovered and then heated, and said sludge is subjected to acid attack to solubilize the salt, and finally filtration and recovery of the new coagulant are carried out.

Similarly, in particular in United States patent application US2002/0179531, membrane methods have been proposed: a semi-permeable cationic exchange membrane can separate the salts from the sludge, said salts having been solubilized by adjusting the pH using an acid solution.

In other proposals (US2002/0112740 and International patent application WO-A-2004/033732), a biological reactor is used with thermophilic microbiological fauna that provokes solubilization of the desired salt and that is then separated by solid/liquid separation. This then provides an oxide or a hydroxide of the salt, and an acid attack followed by filtration allows the coagulant to be re-formed.

Further, a thermal method is sometimes carried out as disclosed, for example, in U.S. Pat. No. 3,901,804 and WO-A-03/000602. In that method, wet oxidation or oxidation in supercritical water of the drinking water sludge is carried out in order to recover the salt; acidification can then reform a coagulant.

In all of the above, a similar technique is used that consists in the following in succession:
separating/concentrating the salt present in the drinking water sludge;
adding a mineral acid to acidify the reaction medium that is heated to form aluminum or iron salts;
recovering the thus re-formed coagulant by filtration; the coagulant can then be re-used.

However, all of those techniques generate quantity of aluminum or iron salts that is variable since the quantity depends on the amount of salt in the drinking water sludge used as the starting material. Thus, the variable yield of coagulant conversion means that the quality of the coagulant is highly variable. It should be noted that the thermal methods produce a better recovery yield, but it has to be said that they are relatively expensive compared with the cost of a commercial coagulant.

A further disadvantage lies in the fact that carrying out one or the other of the above techniques requires transporting drinking water sludge in large quantities from the treatment station to a purification station or, more generally, to the location where the coagulant contained in the drinking water sludge is recovered, meaning that additional transport costs are considerable. Alternatively, if the recovery method is carried out directly at the drinking water station, a coagulant is generated that nevertheless needs to be transported to a purification station in order to be used, again presenting significant transport costs.

Furthermore, in those techniques, lime is often used for the dehydration step, which firstly gives rise to costs linked to purchase of that starting material, and secondly cannot bring about sufficient dehydration for the volumes of material obtained to be transported economically.

The aim of the present invention is to provide a method that can overcome the disadvantages of the prior art and in particular that can offer the possibility of using drinking water sludge as a source of aluminum or iron salts in order to form a coagulant of quality, and more particularly of iron and/or aluminum salt content, that means that it can be used in the treatment of waste water, while being in a form that is compatible with economically viable transport costs.

To this end, in accordance with the present invention, there is proposed a method of obtaining a coagulant product, which method is characterized in that a starting material is prepared containing sludge resulting from the treatment of drinking water (settling sludge), said sludge being enriched with an ore containing iron and/or aluminum, said starting material undergoing acid attack in order to form iron salts, aluminum salts, or a mixture thereof, in the form of simple salts and/or compound salts.

Compared with the prior art in which sludge resulting from the treatment of drinking water is prepared, then said product undergoes acid attack by heating, and then filtering, there is thus proposed a method of obtaining a coagulant product that is distinguished by the fact that the drinking water sludge has been enriched in Fe³⁺ and/or Al³⁺ ions.

In this manner, it is understood that by adding an iron and/or aluminum ore, the drinking water sludge is doped with iron and/or aluminum to the desired amount that depends on the desired final amount of iron and/or aluminum in the coagulant. It should be noted that doping (enrichment) does not have to be carried out with an iron ore and/or aluminum ore, but can also be achieved by adding one of these two metals.

This solution also has an additional advantage, in addition to a saving on ore compared with the traditional method of producing a coagulant, namely that of providing an avenue for commercialization of the drinking water sludge that has been upgraded thereby.

According to the invention, the method advantageously comprises the following steps:

a) producing an initial mixture between sludge resulting from the treatment of drinking water and powder of an ore containing iron and/or aluminum, by means of which the sludge is doped;

b) dehydrating the initial mixture to form a starting material (for example in the form of a cake or granules);

c) subjecting the starting material to an acid attack, with initial heating, and using a mineral acid, by means of which an intermediate product is formed that contains iron salts, aluminum salts, or a mixture thereof; and

d) filtering the intermediate product to separate the solid phase from the liquid phase containing said coagulant product.

In general, the solution of the present invention makes it possible to obtain, from drinking water sludge and iron and/or aluminum ore, a dehydrated starting material with a dry solids content sufficient for transport purposes. In this situation, the final phase of the method of producing the coagulant, namely the recovery-generation phase (steps c) and d), acid attack, and filtration), is advantageously carried out at the user's site, namely principally a purification station, or at a site dedicated to this procedure.

Alternatively, all of the steps of the method resulting in the formation of coagulant at the drinking water sludge supplier's site may be carried out before transporting it to the user's site.

In accordance with a possible implementation of the method of the invention, the method advantageously comprises the following steps:

a′) adding powder of an ore containing iron and/or aluminum during the step of clarification treatment of the drinking water, by means of which an initial mixture is obtained;

b) dehydrating the initial mixture to form a starting material;

c) subjecting the starting material to an acid attack, with initial heating, and using a mineral acid, by means of which an intermediate product is formed that contains iron salts, aluminum salts, or a mixture thereof; and

d) filtering the intermediate product to separate the solid phase from the liquid phase containing said coagulant product.

Thus, in this situation step a) becomes step a′) that is carried out during clarification (coagulation-flocculation-decanting) of the water. The ore containing iron and/or aluminum acts as a support for floc during clarification in order to recover a sludge doped with active material and to encourage sedimentation and elimination of material in suspension and organic materials.

Particularly advantageously, prior to step a), the ore is charged, preferably using a polyelectrolyte that may be ionic (cationic or anionic) or non-ionic, acting as a flocculating agent for the ore. Charging the ore can improve its capacity as a structuring agent for dehydration step b).

This charging may also include the introduction of lime, however in smaller quantities than in a conventional step preparatory to dehydrating drinking water sludge.

Preferably, acid attack step c) is carried out using hydrochloric acid or sulfuric acid, but it should be noted that any mineral acid can be suitable.

Dehydration step b) is preferably carried out using a filter press and/or a membrane filter press.

In this situation, not carrying out dehydration using lime, which is conventionally used in the treatment of drinking water sludge, in particular when carrying out calcium amelioration, economizes on this starting material.

Further, in the invention, the role of structuring agent played by lime during the dehydration step in a conventional drinking water sludge treatment is, played by an ore that is advantageously charged, in particular by a polyelectrolyte.

Preferably, to further increase the dry solids content of the starting material, the method further comprises, after dehydration step b), a complementary step of dehydrating the starting material by drying, filter pressing and/or membrane filter pressing.

Further, the present invention provides to the coagulant resulting from said production method and deriving from both an iron and/or aluminum ore and drinking water sludge.

In accordance with a further aspect, the present invention provides to a product intended to allow the production of a coagulant for the treatment of waste water and/or industrial water, comprising sludge deriving from a drinking water treatment plant enriched with an ore containing iron and/or aluminum.

Advantageously, said product further includes a polyelectrolyte, ionic (cationic or anionic) or non-ionic, acting as a flocculating agent for the ore. The presence of said electrolyte charges the ore, which can improve its capacity as a structuring agent for the dehydration step.

Said product may correspond to the initial mixture (doped sludge) formed from the sludge resulting from the treatment of drinking water and doped by the ore containing Fe³⁺ and/or Al³⁺ ions, or said product may correspond to the dehydrated doped sludge which, at the end of the dehydration step, forms said starting material.

In accordance with a preferred embodiment, said product has a dry solids content of more than 25% by weight, the dry solids content of said product preferably being in the range 35% to 90% by weight. A sufficiently high dry solids content for compatibility with transport requirements is obtained in particular when said product is formed from the starting material resulting from steps a) and b) (doping the sludge with the ore and dehydration) before carrying out steps c) and d) (acid attack and filtration) of the method mentioned above.

Further, the present invention provides a method of the treating water and/or industrial water, including a physico-chemical step using a coagulant, the method being characterized in that said coagulant comprises an ore electrolyte based on a trivalent ion at least partially deriving from sludge from the drinking water treatment line, said sludge being enriched with an ore containing iron and/or aluminum.

Preferably, said coagulant comprises one or more salts, which may be simple or compound, selected from the group formed by iron and aluminum salts.

In particular, said physico-chemical step is a physico-chemical dephosphatation, a coagulation step, a dehydration step, a decarbonation step, or an emulsion breaking step.

Thus, it should be understood that the coagulant produced in accordance with the invention from a mixture of drinking water sludges and ore, in particular iron and/or aluminum ore, may have a large number of avenues for commercialization in the water treatment field.

Said coagulant may also be of use in other fields, in particular as a binder for the production of concrete, or in the production of paper in the wet chemistry part of the process/machine.

Other advantages and characteristics of the invention become apparent from the following description, made by way of example and with reference to the single FIGURE that is a block diagram for an embodiment of the method of the invention.

Firstly (stage 10), the drinking water sludge containing the coagulant that is to be isolated and recovered is doped.

To this end, an ore containing aluminum, Al³⁺, and/or iron, Fe³⁺, ions is mixed with drinking water sludge deriving from the treatment of drinking water, to produce the initial mixture of this doped sludge.

Preferably, and as shown in the single FIGURE, prior to producing said mixture, a polymer acting as a polyelectrolyte is added to the iron and/or aluminum ore to charge the ore. Said polyelectrolyte may be ionic (cationic or anionic) or non-ionic.

In this manner, the charged ore is then able to act as a structuring agent for the drinking water sludge in the subsequent dehydration phase. Further, during mixing of the charged ore and the drinking water sludge, flocculation occurs that can facilitate subsequent dehydration.

During this second dehydration stage 20, which may consist of a plurality of steps, a mechanical system is used such as a membrane filter or a filter press, the action of which may be combined with a complementary step of dehydration by drying or using a filter (filter press or membrane plate filter press). Thus, filter press dehydration may achieve dry solids contents of more than 25%, in particular 35% to 55%. Drying can achieve dry solids contents of the order of 90%.

It is also possible to carry out the dehydration step 20 by drying alone; there is then no point in charging the ore by adding a polyelectrolyte.

At the end of said dehydration step, the initial mixture or doped sludge generates two novel products formed from the liquid portion, in the form of a filtrate, and from the solid portion in the form of a dehydrated doped sludge termed the starting material (cake or granules).

In fact, it is this starting material that is used to produce the coagulant in the remainder of the production method.

Thus, as discussed above, a dry solids content of 25% to 90% may more generally be attained, which considerably reduces the volume of the starting material to be transported when the final coagulant production phase is carried out elsewhere.

Finally, during the third stage of the coagulant production method, the coagulant is formed using two successive steps: acid attack and filtration.

During the acid attack step, excess mineral acid is added to the dehydrated doped sludge, then the mixture is heated to a temperature of the order of 80° C. for several hours. During this step, steam escapes from the receptacle containing the reaction medium and the reaction of the acid with the iron ions or the aluminum ions results in the formation of iron and/or aluminum salts. Any mineral acid can be suitable, such as hydrochloric acid, sulfuric acid or phosphoric acid.

The reactive material that is formed at the end of the acid attack forms an intermediate product.

Thus, for example, when hydrochloric acid is used, the following is obtained:
aluminum chloride, AlCl₃, starting from alumina:

Al(OH)₃+3HCl→AlCl₃+3H₂O
ferric chloride starting from iron oxide:

Fe₂O₃+6HCl→2FeCl₃+3H₂O

During this step, this polymer may undergo partial hydrolysis in the heated acid medium in the presence of polyelectrolyte: the residual amount of polyelectrolyte can advantageously act by flocculation to encourage better dehydration of the intermediate product during the final filtration step.

During the filtration step, a filter press is preferably used, optionally combined with a plate membrane type filter press.

At the end of said filtration step, the solid phase, constituting a residue, is separated from the liquid phase that is recovered in order to constitute the coagulant, due to the presence of iron and/or aluminum salts (aluminum or iron chloride, aluminum sulfate Al₂(SO₄)₃ or iron sulfate if sulfuric acid is used in the acid attack step).

When sulfuric acid is used during the acid attack, if the ore used is an iron ore, ferrous sulfate is obtained that may then be oxidized using pure oxygen or ferric sulfate/chloride using a technique that is well known to the skilled person.

It should be noted that the acid used may itself derive from an industrial residue such as a pickling liquor.

At the end of the method, a liquid is thus obtained that contains a salt (for example a chloride or a sulfate) of a liberated and dissolved trivalent ion, here Al³⁺ or Fe³⁺.

This liquid may act as a coagulant in any conventional application, in particular carrying out a physico-chemical step of the treatment of waste water and/or industrial water, such as physico-chemical dephosphatation. In this example, precipitation of phosphorus is carried out by the Al³⁺ or Fe³⁺ ions to form the salts AlPO₄ or FePO₄, which are highly insoluble, precipitating in the colloidal state, said precipitate then being eliminated by flocculation with an excess of metallic hydroxide.

Other application examples that may be mentioned include the use of said coagulant in a coagulation step (for example to improve a subsequent liquid settling step), a dehydration step, a carbonation step, or an emulsion breaking or coagulation step, whether this is carried out for the treatment of waste water and/or industrial water or in other applications.

By way of illustration, there follows a quantitative example of an implementation of a method in accordance with the present invention.

In this example, 1 kg [kilogram] of aluminum oxide ore containing 98% of Al(OH)₃ per kilogram of treated drinking water sludge was used.

First stage: Doping the sludge

262.5 kg of ore containing 0.32 g [gram] of aluminum per gram of ore was used (this corresponded to introducing 84 kg of aluminum for a total of 262.5 kg of dry solids).

Firstly, the ore was charged using a polyelectrolyte type polymer. In the example, 2 grams per liter of active anionic polymer was used in a volume of 1575 L [liter], which corresponded to a total of 3115 kg of dry solids.

The charged ore was then mixed with 6348.4 L of sludge from a drinking water plant in the south of the Paris region, which contained 0.061 kg of aluminum per kilogram of dry solids and 41.35 g of dry solids per liter, which corresponded to a total of 262.5 kg of dry solids comprising 16 kg of aluminum.

To produce this mixture, for example, the method or the flocculation reactor presented in document WO-A-2005/065832 can be used.

During mixing, flocculation of the drinking water sludge was observed due to the presence of ore that acted as a structuring agent, this phenomenon being further accentuated by the polyelectrolyte.

Following mixing, a volume of 7923.4 L of doped sludge containing 0.19 kg of aluminum per kilogram of dry solids was obtained, i.e. 100 kg of recovered aluminum contained in 528.15 kg of dry solids.

### Second Stage: Dehydrating the Doped Sludge

Secondly, the doped sludge dehydratation phase was carried out using a filter press. During this step, a stack of successive layers of doped sludge was produced in the space formed between each pair of two plates of the filter press, which was placed under a pressure of up to 15 bar.

At this stage, it should be noted that it is also possible to use (not shown), alternatively or in combination with such a filter press, a membrane plate filter that is placed under a pressure of up to seven bar, this solution being particularly advantageous if the sludge contains particles of very small size.

In the present implementation, at the end of the dehydration step, the following was obtained:
a filtrate representing a volume of 7923.4 L and containing 0.7 g of dry solids per liter including 2.5 mg [milligram] of aluminum per liter, i.e. a total of 0.6 kg of aluminum per 4.59 kg of dry solids; and
dehydrated doped sludge forming 1415.11 kilograms of starting material having the following characteristics: an aluminum content of 0.17 kg per kilogram of dry solids and a dry solids content of 37%, which corresponded to a total of 89 kg of recovered aluminum and 523.59 kg of starting material.

### Third Stage: Formatting of Coagulant by Recovery-Regeneration.

During the final phase of the production method, the above-specified starting material was mixed with 2667.83 L of 37.6% hydrochloric acid (in excess), then all heated to 80° C., leaving this exothermic reaction to run for two hours. At the end of this acid attack step, the final filtration step was carried out using the same type of filter press as that used during the previous dehydration phase or using a drum vacuum filter, to finally result in the formation:
of 91.23 kilograms of a solid residue (i.e. 17.4% of the dry solids introduced); and
3247.8 L of a solution of coagulant containing aluminum chloride, AlCl₃, with a density of 1.18, an aluminum content of 27.3 g per liter and a percentage of alumina, Al₂O₃, of 5.16%, i.e. a total of 88.7 kilograms of recovered aluminum.

In this example, then, a yield of 88.7% of aluminum was recovered.

In general, the tests carried out have demonstrated a recovery of more than 85% for aluminum and more than 95% for iron.

The use of this solution of coagulant in a dephosphatation treatment step has shown equivalent results in terms of the degree of phosphorus reduction.

Further, in the example presented above, we started from an initial mass equal to the dry solids content of the ore and the dry solids content of the drinking water sludge, but it should be understood that this distribution could be modified to obtain a final solution of coagulant with the desired content, in particular a content analogous to commercial coagulants.

Further, in this implementation, the starting sludge and ore both contained aluminum, but it is possible to start from sludges and ore both containing ferric ions, or sludges and ore one of which contains aluminum and the other contains ferric ions. In this latter case, it would be possible to start from a drinking water sludge containing ferric ions, that sludge being doped with an aluminum ore, so that finally, a coagulant would be obtained with a mixed salt that would have many uses, and have the desired content.

Compared with implementing the current method of producing a coagulant solely from drinking water sludge, this method has the particular advantage of producing the same quantity of coagulant from a smaller quantity of starting material, namely in the first case from drinking water sludge and in the second case from the initial mixture (sludge doped with ore), which substantially reduces the volumes of material to be transported and treated. Further, by doping with ore, a coagulant can be obtained with an iron and/or aluminum salt content that is raised to the desired value.

By way of example, without doping with ore as in the invention, simply with drinking water sludges, in general one would obtain a coagulant having an aluminum salt content of 1% or 2% (5% to 10% for iron salts) as opposed to up to 8% with doping (at least 32% for iron salts).

In comparison with carrying out a prior art method of producing a coagulant solely from ore, the method of the invention has the particular advantage of using less ore, and thus economizing as regards purchasing and transport of ore. Again, this method can provide avenues for commercialization as regards providing useful material from drinking water sludge, which is normally considered to be a waste product, and as regards producing a coagulant salt that can be used in the waste water treatment line, thereby limiting the overall volumes of sludge produced by the two lines to an extraordinary extent.

As an example, the drinking water sludges recovered throughout the Île de France contain a quantity of trivalent salts that could by itself cover approximately 70% to 80% of the sanitation needs for the purification stations of the same region.

Preferably, in the implementation given above by way of example, the starting material resulting from dehydration is transported to the site for final production of coagulant that may be the purification station that will need said coagulant when carrying out waste water treatment steps.

Alternatively, operating the waste water treatment and coagulant production may be dedicated to an external site. In particular, this site could centralize recovery of dehydrated doped sludge or starting materials deriving from different drinking water treatment stations to carry out the third and last phase of the coagulant production method.

It should be understood that the method that is presented above may be carried out to produce different types of ore coagulants, in particular aluminum chloride, aluminum sulfate, iron chloride or sulfate, polyaluminum chloride (PAC) or polyaluminium chloride-sulfate (PACS) or mixed iron and/or aluminum salts.

1. A method of obtaining a coagulant product, wherein a starting material is prepared containing sludge resulting from the treatment of drinking water, said sludge being enriched with an ore containing iron or aluminum or iron and aluminum, said starting material undergoing acid attack in order to form iron salts, aluminum salts or a mixture thereof.

2. A method according to claim 1, comprising:
a) producing an initial mixture between sludge resulting from the treatment of drinking water and powder of an ore containing iron or aluminum or iron and aluminum;
b) dehydrating the initial mixture to form a starting material;
c) subjecting the starting material to an acid attack, with initial heating, and using a mineral acid, by means of which an intermediate product is formed that contains iron salts, aluminum salts, or a mixture thereof; and
d) filtering the intermediate product to separate the solid phase from the liquid phase containing said coagulant product.

3. A method according to claim 1, comprising:
a′) adding powder of an ore containing iron or aluminum or iron and aluminum during the step of clarification treatment of the drinking water, by means of which an initial mixture is obtained;
b) dehydrating the initial mixture to form a starting material;
c) subjecting the starting material to an acid attack, with initial heating, and using a mineral acid, by means of which an intermediate product is formed that contains iron salts, aluminum salts, or a mixture thereof; and
d) filtering the intermediate product to separate the solid phase from the liquid phase containing said coagulant product.

4. A method according to claim 2, wherein prior to step a), the ore is charged using a polyelectrolyte.

5. A method according to claim 2, wherein step c) is carried out using hydrochloric acid or sulfuric acid.

6. A method according to claim 2, wherein step b) is carried out using a filter press or a membrane filter press or a filter press and a membrane filter press.

7. A method according to claim 2, further comprising: after step b), further dehydrating the starting material by drying, filter pressing, membrane filter pressing or filter pressing and membrane filter pressing.

8. A coagulant product for the treatment of waste water or industrial water or waste water and industrial water obtained by acid attack of a starting material comprising sludge deriving from a drinking water treatment plant enriched with an ore containing iron or aluminum or iron and aluminum.

9. A coagulant product according to claim 8, wherein said starting material further comprises a polyelectrolyte.

10. A coagulant product according to claim 8, wherein said starting material has a dry solids content of more than 25%.

11. A method of treating waste water or industrial water or waste water and industrial water, including a physico-chemical step using a coagulant, wherein said coagulant comprises an ore electrolyte based on a trivalent ion at least partially derived from a starting material containing sludge from a drinking water treatment line, said sludge being enriched with an ore containing iron or aluminum or iron and aluminum, said starting material having undergone acid attack to form iron salts, aluminum salts or a mixture thereof.

12. A method according to claim 11, wherein said physico-chemical step is a physico-chemical dephosphatation, a coagulation step, a dehydration step, a decarbonation step, or an emulsion breaking step.

13. A method according to claim 11, wherein said coagulant comprises one or more salts selected from the group formed by iron salts and aluminum salts.

14. A method according to claim 3, wherein prior to step a′), the ore is charged using a polyelectrolyte.

15. A method according to claim 4, wherein step c) is carried out using hydrochloric acid or sulfuric acid.

16. A method according to claim 4 wherein step b) is carried out using a filter press or a membrane filter press or a filter press and a membrane filter press.

17. A method according to claim 3, further comprising:
after step b), further dehydrating the starting material by drying, filter pressing, membrane filter pressing or filter pressing and membrane filter pressing.

18. A coagulant product according to claim 9, wherein said starting material has a dry solids content of more than 25%.

19. A method according to claim 12, wherein said coagulant comprises one or more salts selected from the group formed by iron salts and aluminum salts.
